(19) United States
(12) Patent Application Publication
(10) Pub. No.: US 2011/0236783 A1
(43) Pub. Date: Sep. 29, 2011

(54) INTERDIGITATED FLOW FIELD FOR SOLID PLATE FUEL CELLS

(76) Inventor: Robert M. Darling, South Windsor, CT (US)

(21) Appl. No.: 13/133,511

(22) PCT Filed: Jan. 16, 2009
(86) PCT No.: PCT/US09/31203

§ 371 Date: Jun. 8, 2011

(51) Int. Cl. H01M 8/04

(52) U.S. Cl. 429/444; 429/514

(57) ABSTRACT

A fuel cell includes a first flow field plate for an anode side and a second flow field plate for a cathode side where each of the first flow field plates include channels configured to provide matching interdigitated flow fields. The fuel cell includes the first flow plate that receives fuel and a second flow plate arranged on an opposite side of the polymer electrolyte membrane for receiving an oxidant. Each fuel flow plate includes ribs that separate inlet channels from outlet channels. Inlet flow entering the inlet channel is directed over these ribs into an adjacent outlet channel. The outlet channel then provides for outlet flow of the fuel, oxidant and water. Because a solid plate polymer electrolyte fuel cell does not include flow field plates having a porous configuration, water management is difficult to balance and is accomplished through the polymer electrolyte membrane. The disclosed fuel flow plates are matched to define and manage water flow through the polymer electrolyte membrane of the fuel cell.

### BACKGROUND

Fuel cells are useful for generating electrical energy based upon an electrochemical reaction. A required function in fuel cells is directing reactants in a desired manner through the fuel cell. Flow field plates typically include channels through which fluids flow during fuel cell operation. For example, fuel and air are directed along flow field channels such that the fuel and air are available at a catalyst layer of a polymer electrolyte membrane fuel cell.

Typical flow field channel arrangements have a plurality of inlets on one region of the plate and corresponding outlets in another region. In conventional arrangements, ribs on the flow field plate separate the individual channels.

Interdigitated flow field arrangements differ from conventional flow field arrangements by directing fluid to enter the inlet of one channel, but exit the outlet of another channel. Fluid flowing in each inlet channel is effectively diverted into two separate outlet channels with approximately one-half of the flow from each inlet channel going into a corresponding outlet channel. Interdigitated flow field arrangements are known for use on the air side of porous plate fuel cells because water management is accomplished substantially by the porous plates. However, a solid plate fuel cell complicates the water management function because water is transferred only through the polymer electrolyte membrane instead of porous plates to control water outflow.

Accordingly, an arrangement that aids water transfer and management through the polymer electrolyte membrane is desirable to further improve performance of a solid plate fuel cell.

### SUMMARY

An example fuel cell device includes a first flow field plate for an anode side and a second flow field plate for a cathode side where each of the first flow field plates include channels configured to provide matching interdigitated flow fields.

The disclosed example fuel cell includes the first flow plate that receives fuel and a second flow plate arranged on an opposite side of the polymer electrolyte membrane for receiving an oxidant. Each flow plate includes ribs that separate inlet channels from outlet channels. Inlet flow entering the inlet channel is directed over these ribs into an adjacent outlet channel. The outlet channel then provides for outlet flow of excess reactants and water. Because a solid plate polymer electrolyte fuel cell does not include flow field plates having a porous configuration, water management is difficult to balance and is accomplished through the polymer electrolyte membrane. Accordingly, the disclosed example flow plates are matched to define and manage water flow through the polymer electrolyte membrane of the fuel cell.

The various features and advantages of this invention will become apparent to those skilled in the art from the following detailed description. The drawings that accompany the detailed description can be briefly described as follows.

### BRIEF DESCRIPTION OF THE DRAWING

FIG. 1 is a schematic representation of an example solid plate fuel cell.

FIG. 2 is a plan view of a first flow field plate.

FIG. 3 is a plan view of a second example flow field plate.

FIG. 4 is a plan view of another example flow field plate.

FIG. 5 is an example of an alternate flow field plate.

### DETAILED DESCRIPTION

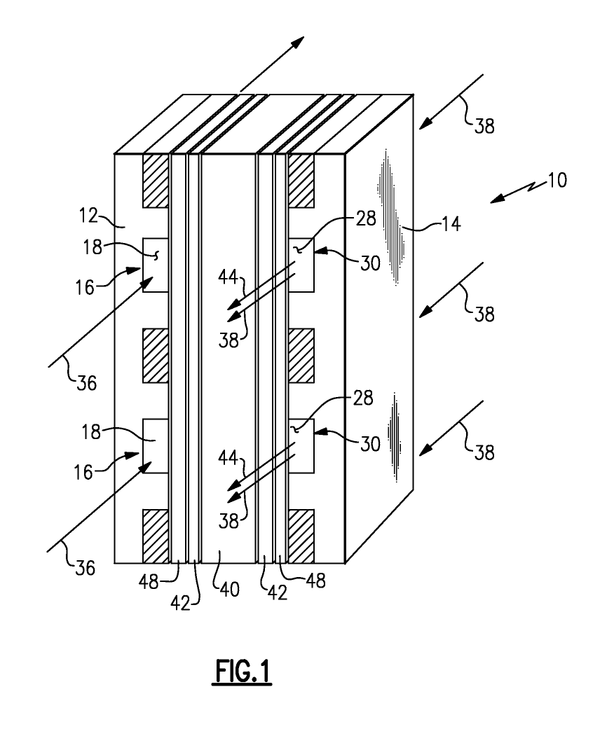

Referring to FIG. 1, an example fuel cell assembly 10 includes a first flow field plate 12 disposed on an anode side of a polymer electrolyte membrane 40. A second flow field plate 14 is disposed on a cathode side of the polymer electrolyte membrane 40. Catalytic layers 42 and gas-diffusion layers 48 are disposed between each of the flow field plates 12, 14, and the membrane 40. The catalytic layers 42 encourage the electrochemical reactions that facilitate generation of electrical energy by the fuel cell assembly 10.

The first flow field plate 12 includes a plurality of inlets 16 that lead to inlet channels 18. The second flow field plate 14 includes outlets 30 that lead from outlet channels 28. Oxidant 38 is fed into the second plate 14 and fuel 36 is fed into the first flow field plate 12. None of the inlet channels 18 or outlet channels 28 provide for a direct flow of oxidant 38 and the fuel 36 through the corresponding flow field plate 12, 14. Instead, each flow field plate 12, 14, feeds the outlet channels through adjacent inlet channels separated by ribs. Fuel 36 and oxidant 38 is transferred over a corresponding rib to provide an interdigitated flow that matches high and low pressure and water content regions of the two flow fields to facilitate the desired balance of water generation and flow through the polymer membrane 40.

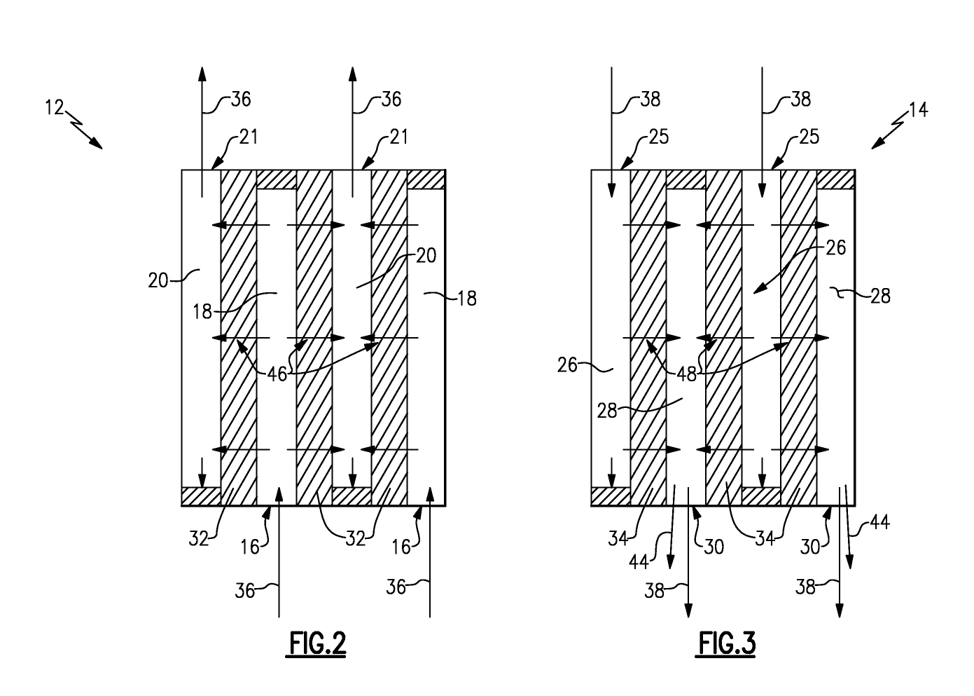

Referring to FIG. 2, the first flow field plate 12 communicates fuel 36 to the catalyst layer 42 and includes inlet channels 16 that are each disposed adjacent a corresponding outlet channel 20. A corresponding plurality of ribs 32 define the inlet channels 18 and outlet channels 20. Fuel flow 36 entering the inlet channel 18 is prevented from flowing completely through the first flow field plate 12 and is transferred over the ribs 32. The ribs 32 generate an inter-mixing interdigitated flow indicated by arrows 46 between and over the ribs 32 into the corresponding adjacent outlet channel 20. From the outlet channel 20, the fuel 36 is exhausted through outlets 21 from the fuel cell.

Referring to FIG. 3, the second flow field plate 14 is provided for oxidant flow and is disposed on an opposite side of the polymer membrane 40 from the first flow field plate 12. The inlet channels 26 of the second flow field plate 14 are disposed in a counter orientation relative to the first flow field plate 12. In other words, inlets 25 feeding the inlet channels 26 are disposed on an opposite of the second flow field plate 14 as compared to the inlets 16 of the first flow field plate 12. The counter flow between the first and second flow field plates 12, 14 provide a desired mixing and matching of the fuel and oxidant flows.

The second flow field plate 14 includes the outlet channels 28. From the outlet channels 28 emerges oxidant 38 along with water 44. Water 44 represents that excess not required to maintain the polymer membrane 40 in a desired wetted state.

The ribs 34 in the second flow plate 14 are longitudinally aligned with the ribs 32 in the first flow plate 12. The matching alignment of the ribs 32 and 34 provide a matched flow field between oxidant 38 flowing through the second flow field plate 14 and the fuel 36 flowing through the first flow field plate 12. The matching flow fields coordinate high and low pressure and high and low water content regions in each flow field plate 12, 14 to provide the desired balance of water through the polymer membrane 40.

The matching ribs 32, 34 and corresponding inlet and outlet channels provide the capacity to exchange water between the two flow fields in a proportional manner required to maintain the desired water balance. The identical configurations of the first and second flow field plates 12, 14 matches the fuel flow field and the oxidant flow field as required to provide the desired water management that maintains optimal operation of the fuel cell assembly 10.

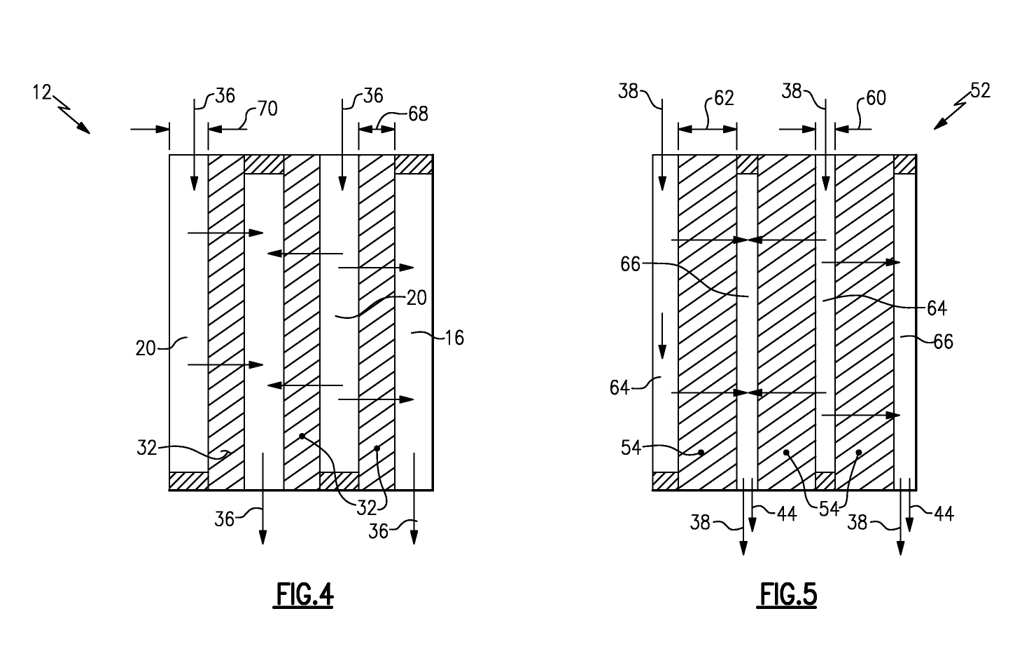

Referring to FIGS. 4 and 5, the previous example included flow field plates 12, 14 having identical configurations; it is also within the contemplation of this invention that the flow field plates may have different configurations to tailor differing flow fields with desired water management requirements. For example, the ribs and channels for each of the flow places can include different widths on the air and fuel sides.

The example first flow field plate 12 indicated at FIG. 4 is identical to the previous flow field plate receiving fuel as was described in regard to FIG. 2. However, the flow field plate 52 illustrated in FIG. 5 includes a different configuration relative to the flow field plate 12. The flow field plate 52 includes wider ribs 54 aligned with the ribs 32 in the first flow field plate 12. The increased width rib 54 creates different flow field performance to match flow field characteristics present in the first flow field plate 12.

The proportion of overlapping flow fields through each of the flow field plates 12, 52 determines the flow of water through the membrane 40. The exchange of water is tailored by adjusting flow field parameters, such as increasing or decreasing high and low pressure regions. In the example embodiment, the desired exchange of water is tailored by changing the relative size in channels between the first flow field plate 12 for fuel and the second flow field plate 52 for oxidant.

The example channels 66 and 64 are of a reduced in size relative to corresponding channels 20 and 18 in the first flow field plate 12. The difference sized channels match specific high and low pressure portions within the second flow field plate 52 with a corresponding high and low pressure flow field within the first flow field plate 12 to provide the desired water exchange rate between the two flow fields.

In this example, the ribs 54 include a width 62. The width 62 is larger in the second flow field plate 52 than the width 68 in the first flow field plate 12. Further, the channels 64 and 66 in the second flow field plate 52 includes a width 60 that is much smaller than the width 70 of the inlet and outlet channels 20, 16 that is disposed within the first flow field plate 12.

As is appreciated a worker skilled in the art can adjust the widths of the ribs and channels relative to each to provide a desired exchange of water between the two flow fields and water flow rate through the membrane 40. Further, although the example discloses the oxidant flow field plate having different channel and rib widths, the fuel side flow field plate could also be configured to included differing sized channels to tailor water exchange between the two flow fields to optimize operation of the fuel cell.

Accordingly, the example fuel cell assembly includes solid plates that include features to match and define flow fields on either side of the polymer electrolyte membrane in order to provide the desired water management and exchange and improve operation of the fuel cell assembly.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A fuel cell comprising:
a first flow field plate for an anode side including a plurality of outlet flow channels and a corresponding plurality of inlet flow channels, the flow channels being arranged such that at each of the inlet flow channels are immediately adjacent at least one of the outlet flow channels; and
a second flow field plate for a cathode side including a plurality of outlet flow channels and a corresponding plurality of inlet flow channels, the flow channels being arranged such that each of the inlet flow channels are immediately adjacent at least one of the outlet flow channels.

2. The fuel cell as recited in claim 1, wherein the first flow field plate and the second flow field plate comprise solid, non-porous structures.

3. The fuel cell as recited in claim 1, wherein the inlet channels of the first flow field plate are aligned with the inlet channels of the second flow field plate

4. The fuel cell as recited in claim 1, wherein a fluid inlet for each of the inlet channels of the first flow field plate are disposed on a side opposite a fluid inlet for each of the inlet channels of the second flow field plate providing counter flows of fluids through the fuel cell.

5. The fuel cell as recited in claim 1, wherein each of the first and second flow field plates comprise a plurality of ribs separating each inlet channel from each outlet channel, where fluid transfers across the rib from the inlet channel to the outlet channel.

6. The fuel cell as recited in claim 5, wherein the plurality of ribs of the first and second flow field plates are aligned longitudinally with each other.

7. The fuel cell as recited in claim 5, wherein each of the plurality of ribs within each of the first and second flow field plates comprise a common width.

8. The fuel cell as recited in claim 5, wherein the plurality of ribs in the first and second flow field plates include a width, with at least one width in the first flow field plate being different than at least one width in the second flow field plate.

9. The fuel cell as recited in claim 5, wherein a width of each of the plurality of ribs in the first flow field plate is matched to a width in a corresponding rib in the second flow field plate to match flow fields between the first and second flow field plates.

10. The fuel cell as recited in claim 1, wherein a first flow field of fluid in the first flow field plate is matched with a second flow field of air in the second flow field plate to provide a desired exchange of water between the first and second flow fields.

11. A method of operating a fuel cell including the steps of:
flowing a fuel into a first plurality of inlet channels in a first flow field plate in a first direction and transferring fuel to an adjacent one of a first plurality of outlet channels to flow the fuel in a second direction opposite the first direction;
flowing oxidant through into a second plurality of inlet channels in a second flow field plate in the second direction counter to the first direction and transferring oxidant into an adjacent one of a second plurality of outlet channels to flow the oxidant in the first direction; and
matching the a first flow field through the first flow field plate with a second flow field through the second flow field plate to provide a desired water transfer between the first and second flow fields.

12. The method as recited in claim 11, wherein the first and second flow field plates comprise solid non-porous structures.

13. The method as recited in claim 11, including transferring the fuel over at least one first rib disposed between the first inlet channel and the first outlet channel, and transferring the oxidant over at least one second rib between the second inlet channel and the second outlet channel.

14. The method as recited in claim 13, wherein matching the first flow field with the second flow field includes longitudinally aligning the at least one first rib with the at least one second rib.

15. The method as recited in claim 11, including the step of overlapping low pressure areas of the first flow field with high pressure areas of the second flow field.

16. The method as recited in claim 11, including matching interdigitated flow fields within the first flow field plate with an interdigitated flow field within the second flow field plate.
